(19) United States
(12) Patent Application Publication
(10) Pub. No.: US 2017/0001371 A1
(43) Pub. Date: Jan. 5, 2017

(54) SHAPING SYSTEM, SHAPING OBJECT MANUFACTURING METHOD, AND DATA PROCESSING METHOD

(71) Applicant: CANON KABUSHIKI KAISHA, Tokyo (JP)

(72) Inventors: Ikuo Sobue, Kawasaki-shi (JP); Shigeki Sakurai, Yokohama-shi (JP); Noriyuki Suzuki, Tokyo (JP)

(21) Appl. No.: 15/193,706

(22) Filed: Jun. 27, 2016

(30) Foreign Application Priority Data
Jun. 30, 2015 (JP) 2015-131866
Jun. 14, 2016 (JP) 2016-118338

(51) Int. Cl. B29C 67/00

(52) U.S. Cl. CPC B29C 67/0074; B29C 67/0085; B29C 67/0088; B33Y 10/00

(57) ABSTRACT

A shaping system that fabricates a shaping object by stacking a material layer formed based on slice data, the shaping system comprises a control section which controls operations of respective sections of the shaping system. The control section controls the respective sections so that, at a prescribed timing, a marker is formed and stacked on a top surface of a marker support body, image distortion information is acquired from a position of the marker as detected by a marker position detecting section, and a correction process for correcting the slice data is executed.

### BACKGROUND OF THE INVENTION

Field of the Invention

The present invention relates to a shaping system, a shaping object manufacturing method, and a data processing method.

Description of the Related Art

Shaping systems which form a three-dimensional shaping object by stacking a large number of layers are drawing attention. Stack shaping technology of this type is referred to as additive manufacturing (AM), three-dimensional printing, rapid prototyping, and the like. Various shaping methods are proposed to implement the stack shaping technology. Japanese Patent Application Laid-open No. H10-224581 and Japanese Patent Application Laid-open No. 2003-053846 disclose shaping methods utilizing an electrophotographic process while US Patent Application Publication No. 2009/0060386 (Specification) discloses a laser sintering method.

### SUMMARY OF THE INVENTION

In a shaping system, a shape accuracy of a sectional image of each layer (image formation accuracy) and a positional accuracy when stacking the respective layers (stacking accuracy) may have a significant impact on quality of a final shaping object. In particular, in a case where a shaping operation is suspended midway through the shaping of a shaping object, there is a concern that image formation accuracy may decline when restarting the shaping operation. This becomes a major issue with stacking methods involving independently forming images of respective layers and sequentially stacking the images as is the case of the apparatuses according to Japanese Patent Application Laid-open No. H10-224581 and Japanese Patent Application Laid-open No. 2003-053846. However, with the apparatuses disclosed in Japanese Patent Application Laid-open No. H10-224581 and Japanese Patent Application Laid-open No. 2003-053846, distortion of images and variation in image positions are not addressed and image formation accuracy and stacking accuracy are not guaranteed.

US Patent Application Publication No. 2009/0060386 (Specification) discloses a position calibration method for an apparatus adopting a laser sintering method, in which a calibration plate is scanned prior to start of shaping to determine a center reference of an image. However, this method simply adjusts a drawing position of the image to a center of a stage and does not correct distortion of the image itself. In addition, this method cannot be applied to stacking methods involving independently forming images of respective layers and sequentially stacking the images as described in Japanese Patent Application Laid-open No. H10-224581 and Japanese Patent Application Laid-open No. 2003-053846.

The present invention has been made in consideration of the circumstances described above and an object thereof is to improve, in a shaping system adopting a method involving independently forming images of respective layers and sequentially stacking the images to obtain a three-dimensional shaping object, quality and accuracy of a shaping object even when a shaping operation is suspended midway through shaping of the shaping object.

The present invention in its first aspect provides a shaping system that fabricates a shaping object by stacking a material layer formed based on slice data, the shaping system comprising: a control section which controls operations of respective sections of the shaping system; a marker generating section which generates data of a marker; a slice data generating section which generates the slice data by adding data for fabricating a marker support body to become a base on which the marker is stacked to data of a three-dimensional model; a material layer forming section which forms a material layer made of a shaping material based on the data of the marker or the slice data; a stage on which the material layer is stacked; a marker position detecting section which detects a position of the marker stacked on the stage or the marker support body; an image distortion acquiring section which acquires information on image distortion occurring in the material layer from a detection result of the marker position detecting section; and a correcting section which reduces the image distortion with respect to the slice data based on the image distortion information acquired by the image distortion acquiring section, wherein the control section controls the respective sections so that, at a prescribed timing, the marker is formed and stacked on a top surface of the marker support body, image distortion information is acquired from a position of the marker as detected by the marker position detecting section, and a correction process for correcting the slice data is executed.

The present invention in its second aspect provides a shaping object manufacturing method that repetitively performs, a plurality of times, a set of a material layer forming step of forming a material layer made of a shaping material based on slice data generated from three-dimensional model data and a shaping step of sequentially stacking the material layer formed in the material layer forming step, wherein a correction process step of correcting the slice data is inserted between each repetition of the set.

The present invention in its third aspect provides a data processing method used in a shaping system which fabricates a shaping object by performing, a plurality of times, a step of forming a material layer made of a shaping material based on slice data and a step of stacking the material layer, the data processing method comprising the steps of: generating data of a marker for acquiring information used to correct the slice data; and generating the slice data by adding data for fabricating a marker support body to become a base on which the marker is stacked to data of a three-dimensional model, wherein when data of the marker is inserted between the plurality of times of performing the step of forming the material layer, a step of providing an opening corresponding to a shape of the marker in slice data of the material layer formed subsequently to the insertion of the data of the marker is performed.

According to the present invention, in a shaping system adopting a method involving independently forming images of respective layers and sequentially stacking the images to obtain a three-dimensional shaping object, quality and accuracy of a shaping object can be improved even when a shaping operation is suspended midway through shaping of the shaping object.

Further features of the present invention will become apparent from the following description of exemplary embodiments with reference to the attached drawings.

### BRIEF DESCRIPTION OF THE DRAWINGS

FIG. 1 is a diagram schematically showing a configuration of a shaping system according to an embodiment;

FIG. 2 is a circuit block diagram of a shaping controller;

FIGS. 3A to 3C are diagrams illustrating calibration markers and image distortion;

FIG. 4 is a functional block diagram related to calibration and registration;

FIGS. 5A and 5B are flow charts representing calibration and image distortion correction;

FIGS. 6A to 6C are conceptual diagrams of image distortion correction;

FIG. 7 is a conceptual diagram of detection of a registration transfer marker;

FIGS. 8A and 8B are diagrams defining an image area according to an embodiment;

FIG. 9 is a diagram showing a configuration of a shaping system including two process cartridges;

FIGS. 10A and 10B are diagrams for illustrating a re-calibration process;

FIGS. 11A and 11B are diagrams for illustrating a re-calibration process;

FIGS. 12A and 12B are diagrams for illustrating a re-calibration process; and

FIG. 13 is a flow chart for illustrating a re-calibration process.

### DESCRIPTION OF THE EMBODIMENTS

A mode for implementing the present invention will now be exemplarily described with reference to the drawings. It is to be understood that procedures, control parameters, target values, and the like of various types of control including dimensions, materials, shapes, relative arrangements, and the like of respective members described in the following embodiment are not intended to limit the scope of the present invention to the embodiment described below unless specifically stated otherwise.

### Embodiment

### Configuration of Shaping System

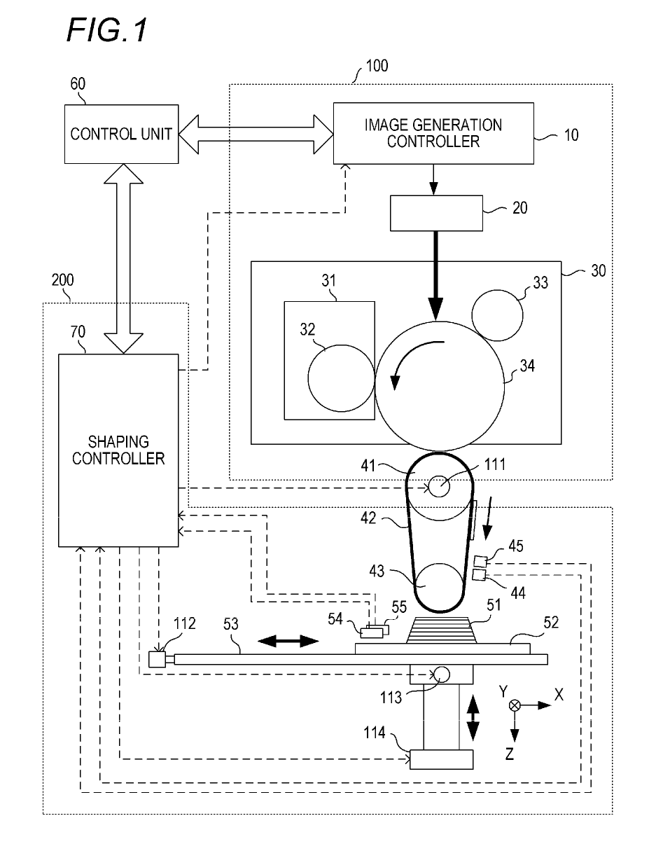

A configuration of a shaping system according to an embodiment of the present invention will be described with reference to FIG. 1. FIG. 1 is a diagram schematically showing a configuration of a shaping system according to an embodiment.

A shaping system is a system which creates a stereoscopic shaping object by stacking a large number of thin films according to a manufacturing method using a stack shaping method. This system is also referred to as an additive manufacturing (AM) system, 3D printer, rapid prototyping (RP) system, and the like.

The shaping system according to the present embodiment roughly includes a material layer forming section 100, a shaping unit 200, and a control unit 60. The material layer forming section 100 is a component which forms a material layer made of a shaping material based on slice data of each layer.

The material layer forming section 100 is constituted by an image generation controller 10, a laser scanner (an exposing apparatus) 20, a process cartridge 30, a transfer roller 41, and the like. The shaping unit 200 is a component which forms a stereoscopic shaping object having a three-dimensional structure by sequentially stacking and fastening images of a plurality of layers formed by the material layer forming section 100. The shaping unit 200 is constituted by a shaping controller, a transfer body 42, a heater roller 43, a stage 52, a stage guide 53, a plurality of motors 111 to 114, a plurality of sensors 44, 45, 54, and 55, and the like. The control unit 60 is a component which performs a process of generating slice data (sectional data) of a plurality of layers from data of a three-dimensional model of a shaping target object, controls various parts of a stereoscopic shaping apparatus, and the like.

(Control Unit)

The control unit 60 includes a slice data generating section which generates slice data for shaping from three-dimensional model data of a shaping target object and a control section which controls operations of various parts including output of slice data of each layer to the image generation controller 10 and management of a shaping step. The control unit 60 can be constructed by, for example, mounting a program having these functions to a personal computer or an embedded computer. As data of a three-dimensional model, data created by a three-dimensional CAD, a three-dimensional modeler, a three-dimensional scanner, and the like can be used. While the data of a three-dimensional model may have any format, for example, polygon data of stereolithography (STL) can be favorably used. In addition, as a format of slice data, for example, multi-valued image data (in which each value represents a type of material) or multi-plane image data (in which each plane corresponds to a type of material) can be used.

(Material Layer Forming Section)

The image generation controller 10 has a function of controlling a material layer forming process by the material layer forming section 100 based on slice data and a control signal which are input from the control unit 60, a control signal which is input from the shaping controller 70, and the like. Specifically, the image generation controller 10 performs a resolution conversion process or a decoding process of slice data, controls an image read position and an image read timing by the laser scanner 20, and the like. In addition, the image generation controller 10 may have functions similar to those of a printer controller built into a general laser printer (2D printer).

The material layer forming section 100 is, for example, a unit which forms a material layer corresponding to one layer made of a shaping material using an electrophotographic process. An electrophotographic process refers to a method of forming a desired image by a series of processes including charging a photoreceptor, forming a latent image by exposure, and causing developer particles to adhere to the latent image to form an image. Although a shaping system uses particles of a shaping material as a developer in place of a toner, a basic principle of an electrophotographic process is approximately the same as that of a 2D printer. While an example in which the material layer forming section 100 uses an electrophotographic process will be described below, the present invention can also be applied to cases where other methods such as an inkjet process are used.

A photosensitive drum 34 is an image bearing member including a photoreceptor layer of an organic photoreceptor, an amorphous silicon photoreceptor, or the like. A primary charging roller 33 is a charging apparatus for uniformly charging the photoreceptor layer of the photosensitive drum 34. The laser scanner 20 is an exposing apparatus which scans an outer surface of the photosensitive drum 34 with laser light and draws a latent image in accordance with an image signal supplied by the image generation controller 10. A shaping material supplying section 31 is an apparatus which stores and supplies a shaping material as a developer. A developing roller 32 is a developing apparatus which supplies the shaping material to an electrostatic latent image on the photosensitive drum 34. The transfer roller 41 is a transfer apparatus which transfers a shaping material image formed on the photosensitive drum 34 to a transfer body (a conveyance body) 42. Although not illustrated, a cleaning apparatus for cleaning the surface of the photosensitive drum 34 may be provided on a downstream side of a transfer nip between the photosensitive drum 34 and the transfer roller 41. In the present embodiment, the photosensitive drum 34, the primary charging roller 33, the shaping material supplying section 31, and the developing roller 32 are integrated as the process cartridge 30 and configured so as to be attachable and detachable with respect to a system main body of the shaping system and to be readily replaceable.

As the shaping material, various materials can be selected in accordance with an application, a function, a purpose, and the like of a shaping object to be created. In the present specification, a material to constitute a shaping object main body will be referred to as a “build material” and a portion constituted by the build material will be referred to as a “build body”. A structure for supporting a build body midway through shaping in a shaping operation will be referred to as a “support body” (for example, a pillar that supports an overhanging portion from below) and a material that constitutes the support body will be referred to as a “support material”. Moreover, when a distinction need not be made between the materials, the term “shaping material” will be simply used. As the build material, for example, a thermoplastic resin such as polyethylene (PE), polypropylene (PP), ABS, and polystyrene (PS) can be used. In addition, as the support material, a material having thermoplastic and water-soluble properties can be favorably used to enable the support material to be readily removed from a shaping object main body. Examples of a material for the support body include carbohydrates, polylactic acid (PLA), polyvinyl alcohol (PVA), and polyethylene glycol (PEG).

(Shaping Unit)

The shaping controller 70 has a function of performing mechatronic control of the shaping apparatus. A drive system includes a transfer roller motor 111 that rotates the transfer roller 41, and a stage X-drive motor 112, a stage Y-drive motor 113, and a stage Z-drive motor 114 which performs three axis movement of the stage 52. A sensing system includes a material front end detection sensor 44 used in online registration, and a material front end detection sensor 45, a material left front end sensor 54, and a material right front end sensor 55 which are used in offline calibration. The roles performed by these sensors and details of online registration and offline calibration will be provided later.

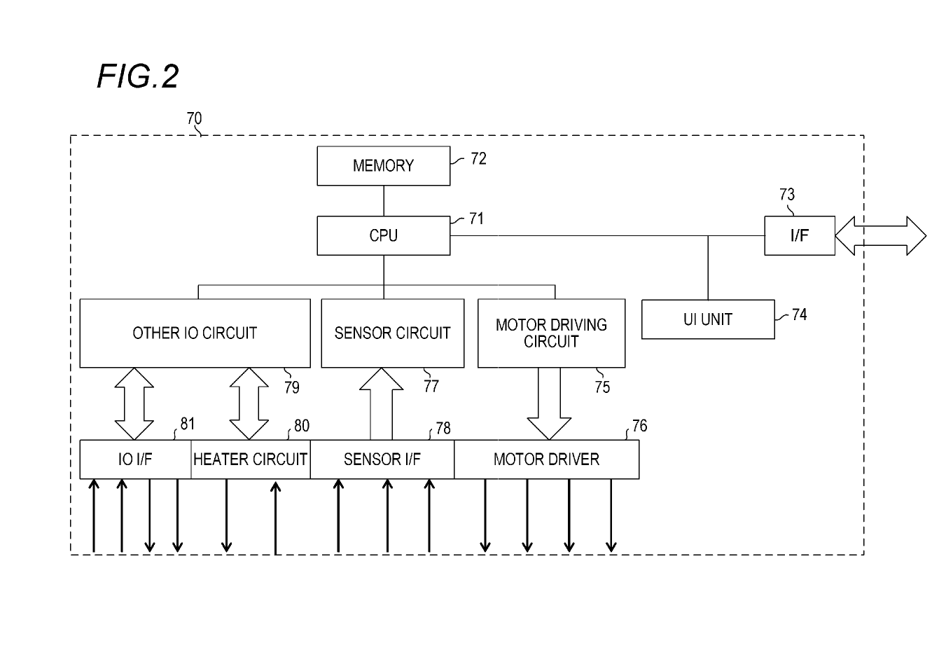

FIG. 2 shows an example of a circuit block of the shaping controller 70. The shaping controller 70 includes a CPU 71, a memory 72, an interface 73, a UI section 74, a motor driving circuit 75, a motor driver 76, a sensor circuit 77, a sensor interface 78, other input/output (IO) circuit 79, a heater circuit 80, and an IO interface 81. The transfer roller motor 111, the stage X-drive motor 112, the stage Y-drive motor 113, and the stage Z-drive motor 114 are connected to the motor driver 76. The material front end detection sensor 44, the material front end detection sensor 45, the material left front end sensor 54, and the material right front end sensor 55 are connected to the sensor interface 78. A heater and a thermocouple inside the heater roller 43 are connected to the heater circuit 80. Although not illustrated, an open cover detection switch of a stereoscopic shaping apparatus, a home position sensor of the stage 52, and the like are connected to the IO interface 81.

The transfer body 42 is a conveying member which bears a material layer formed by the material layer forming section 100 and which conveys the material layer to the stage 52 (a stack nip). The transfer body 42 is constituted by an endless belt made of a resin, polyimide, or the like. The heater roller 43 is a heating and stacking apparatus which has a built-in heater and which melts a material layer on the transfer body 42 and stacks (fastens) the material layer on a shaping object on the stage 52. The stage 52 is a member which holds a shaping object during shaping and can be moved by the stage guide 53 in directions of the three axes of X, Y, and Z.

(Operation of Shaping System)

Next, a basic operation by the shaping system for creating a shaping object will be described.

The control unit 60 generates slice data to be used in shaping with the slice data generating section. For example, three-dimensional model data of a shaping target object is sliced at a prescribed pitch (for example, at a thickness of several microns to slightly more than 10 microns) to generate a slice image of each layer. Subsequently, a registration marker and a slice image of a marker support body (to be described in detail later) are added to the slice image of each layer to generate slice data of each layer. Generation of the slice image of each layer need not necessarily be performed by the control unit 60 and the slice data of each layer may be generated by adding a registration marker and a slice image of a marker support body to a slice image generated outside of the control unit 60. In other words, the slice data generating section need not be dedicated to the shaping system and an external device connected via the Internet may be used as long as the external device is capable of generating slice data and sending the slice data to the shaping system. Slice data is sequentially input to the image generation controller 10 beginning with the slice data corresponding to a lowermost layer. The image generation controller 10 controls laser light emission and scanning by the laser scanner 20 in accordance with input slice data.

In the material layer forming section 100, a surface of the photosensitive drum 34 is uniformly charged by the primary charging roller 33. When the surface of the photosensitive drum 34 is exposed by laser light from the laser scanner 20, an exposed portion thereof is neutralized and a latent image is generated. Shaping material charged by a developing bias is supplied to the neutralized portion by the developing roller 32 and the shaping material is arranged on the surface of the photosensitive drum 34 in accordance with the latent image. This image is transferred onto the transfer body 42 by the transfer roller 41. Hereinafter, a layer made of the shaping material transferred to the transfer body 42 will be referred to as a material layer. When a plurality of types of shaping materials are used, the material layer forming section 100 is provided with process cartridges in a number corresponding to the types of materials. In accordance with slice data, a latent image for each material is generated and the shaping material is arranged at each process cartridge, and a material layer corresponding to one slice is formed by combining the latent images and the shaping materials on the transfer body 42.

The transfer body 42 rotates while bearing the material layer and conveys the material layer to a stack position. Meanwhile, the shaping controller 70 controls the stage 52 so that the stage 52 (or the shaping object on the stage 52) enters the stack position at a same timing and at a same speed as the material layer. In addition, by applying heat with the heater roller 43 while synchronously moving the stage 52 and the transfer body 42, the material layer is thermally welded onto the stage 52 (or onto an upper surface of the shaping object on the stage 52). Each time a material layer is stacked, the shaping controller 70 lowers the stage 52 in a Z direction by a thickness of one layer and stands by to stack a next layer.

By repetitively performing a set of the material layer forming step of forming a material layer and the shaping step (the shaping operation) of stacking the material layer described above for a plurality of times corresponding to the number of pieces of slice data, the shaping object is formed on the stage 52.

Moreover, in the present specification, an object to be created by the shaping system (in other words, an object represented by three-dimensional model data supplied to the shaping system) will be referred to as a “shaping target object” and an object created by (output from) the shaping system will be referred to as a “shaping object”. In addition, when the shaping object includes a support body, the term “build body” will be used when particularly referring to a portion excluding the support body. Furthermore, data including data corresponding to one slice that is obtained by slicing data of a three-dimensional model of a shaping target object will be referred to “slice data” corresponding to one layer. An image corresponding to one layer made of the shaping material which is formed by the material layer forming section based on slice data will be referred to as a “material layer”.

(Problems in Shaping)

With a shaping system of a type (stacking type) in which a large number of material layers are stacked to form a shaping object as in the present embodiment, two factors determine a quality of a final shaping object: shape accuracy of the material layers and positional accuracy during stacking. For example, distortion may occur in a material layer due to scanning accuracy of exposure, dimensional accuracy of a photosensitive drum or a transfer roller, and the like. In particular, distortion may occur in a material layer upon restarting a shaping operation after the shaping operation is suspended midway through the shaping (midway through stacking) of a shaping object. Accumulation of such image distortion has a non-negligible effect on dimensions and a shape of the shaping object. This issue can be considered specific to shaping systems that create a shaping object by stacking material layers when the number of material layers consists of three or more digits.

In consideration thereof, in the present embodiment, in order to secure shape accuracy of a material layer of each layer, information related to image distortion occurring in the material layer forming section 100 is acquired (this is referred to as calibration) and image distortion correction is performed on slice data of each layer when forming a material layer. A feature of the present embodiment is that calibration for acquiring information related to image distortion occurring in the material layer forming section 100 is performed prior to forming an shaping object (this is referred to as offline calibration) and also performed during shaping of the shaping object. For example, when restarting a shaping operation in a case where the shaping operation has been suspended midway through the shaping of a shaping object or when performing shaping over a long period of time, a correction process in which a calibration step is inserted between sets of a material layer forming step and a shaping step which are performed a plurality of times and image distortion correction is applied to slice data of each layer during formation of a material layer will be referred to as a re-calibration process.

In addition, in the present embodiment, in order to secure positional accuracy during stacking, a position of the material layer of each layer on a transfer body is measured and positioning between the material layer and the shaping object on the stage is performed during stacking (this is referred to as online registration). This is a process which addresses an issue in that positional variation which exists when stacking the material layer of each layer on a shaping object causes irregularities to form on a side surface of the obtained shaping object and prevents a smooth surface from being obtained.

Hereinafter, offline calibration, image distortion correction, online registration, and the re-calibration process will be described in detail.

(Offline Calibration)

Offline calibration that is performed before generating a shaping object will be described. In offline calibration, a calibration marker is formed on the stage 52 and information related to image distortion (image distortion information) is acquired based on a deviation of a position of the marker in a similar procedure to the material layer formation and shaping described earlier. Moreover, offline calibration is not limited to before generation of a shaping object and can also be inserted between repetitions of the set of the material layer forming step and the shaping step.

In the following description, image data for a calibration marker supplied to the image generation controller 10 will be referred to as “calibration marker data”. Calibration marker data is stored in, for example, a memory of the control unit 60 and read when performing offline calibration. In addition, an image made of shaping material formed based on calibration marker data will be referred to as a “calibration marker” or simply a “marker”. Furthermore, a marker transferred to the transfer body 42 from the photosensitive drum 34 (in other words, a marker on the transfer body 42) will be referred to as a “calibration transfer marker” and a marker transferred onto the stage 52 will be referred to as a “calibration stack marker”. The name of a marker is changed from one location to another because locations of the marker are favorably distinguished from one another for the same of brevity due to the fact that image distortion may change as the marker is transferred, the marker is detected using a different sensor at each location, and the like. Moreover, in a context where locations need not be particularly distinguished, the term “calibration marker” or “marker” will be used.

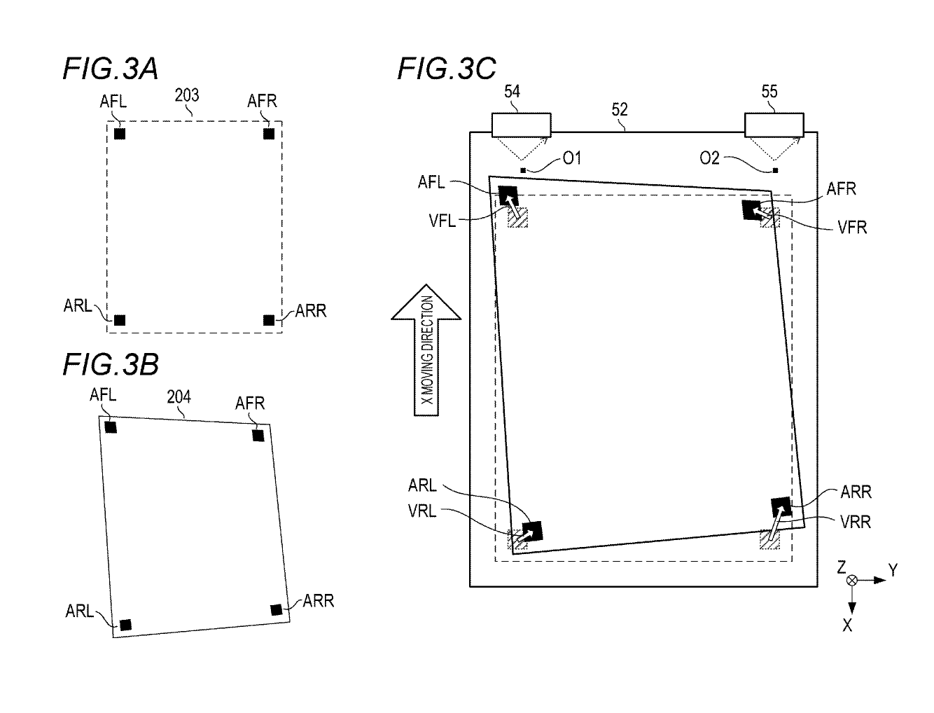

FIG. 3A shows an example of a calibration marker (in a state where there is no image distortion) used in the present embodiment. A square region 203 indicated by a dotted line represents a range (an image area) in which a 200 mm (horizontal) by 300 mm (vertical) image can be formed. A size of the image area 203 is equal to a size of a shaping area (a maximum region in which shaping can be performed) on the stage 52. A front left end calibration marker AFL, a front right end calibration marker AFR, a rear left end calibration marker ARL, and a rear right end calibration marker ARR are placed at four corners of the image area 203. The markers AFL, AFR, ARL, and ARR are 5 mm by 5 mm square images and are generated at centers of 10 mm by 10 mm square regions at the four corners of the image area 203.

FIG. 3B shows an example of a calibration stack marker transferred onto the stage 52. A situation is shown where the image area 204, positions of the markers AFL, AFR, ARL, and ARR at the four corners, and relative positions among the markers have changed due to image distortion occurring during material layer formation and/or shaping.

FIG. 3C is a schematic diagram showing configurations of a stage, a calibration stack marker, and a sensor. An origin O1 and an origin O2 to be used as detection references by the sensor are described on the stage 52. Since the origins O1 and O2 are to be used as dimensional references, high positional accuracy is required. Therefore, the origins O1 and O2 are desirably created by high-accuracy printing such as laser marking or by boring using a high-accuracy NC process. Since detection accuracy of the sensor is also affected, in the case of an optical sensor such as that used in the present embodiment, a printing method or a processing method that produces maximum contrast between an origin and its periphery is desirable. In this case, the origins O1 and O2 are created by laser marking.

Above the stage 52, the material left front end sensor 54 is arranged at a Y position corresponding to the origin O1 and the material right front end sensor 55 is arranged at a Y position corresponding to the origin O2. The material left front end sensor 54 is a sensor for detecting positions of the front left end calibration marker AFL and the rear left end calibration marker ARL. The material right front end sensor 55 is a sensor for detecting positions of the front right end calibration marker AFR and the rear right end calibration marker ARR. Vectors VFL, VFR, VRL, and VRR shown in FIG. 3C respectively represent displacement (a deformation vector) of the markers AFL, AFR, ARL, and ARR with respect to positions of AFL, AFR, ARL, and ARR in a state with no image distortion. The offline calibration according to the present embodiment is a process of actually forming calibration markers on the stage 52 and actually measuring the deformation vectors VFL, VFR, VRL, and VRR which are created due to material layer formation and shaping.

Normally, deformation vectors of the markers at the four corners are not vectors in a same direction. This is because a direction and a magnitude of displacement differ for each position in the shaping area due to distortion of the transfer body 42, a deviation in alignment of each roller shaft, and the like. Therefore, as a calibration marker, a deformation vector need only be acquired for a plurality of points in the shaping area. For example, at least two or more markers are arranged at positions separated from each other in the shaping area on the stage and a deformation vector at each position is detected (measured) and, desirably, markers are arranged at the four corners of a rectangular shaping area as in the present embodiment. A calibration marker constituted by a plurality of markers are not limited, and a frame-like material layer connecting AFL, AFR, ARL, and ARR may be formed as a calibration marker and deformation vectors may be measured at corners of the frame. Accordingly, a displacement occurring at each marker position in the shaping area can be obtained. Moreover, since the use of a hard belt member as the transfer body 42 results in an occurrence of a relatively linear displacement at each position in the shaping area, a deformation vector at positions other than the markers at the four corners can be obtained by linear interpolation of deformation vectors obtained from the markers at the four corners. When deflection of the transfer body 42 is partially periodical or discontinuous, the number of calibration markers may be increased. For example, a plurality of markers are desirably arranged along four sides of the shaping area.

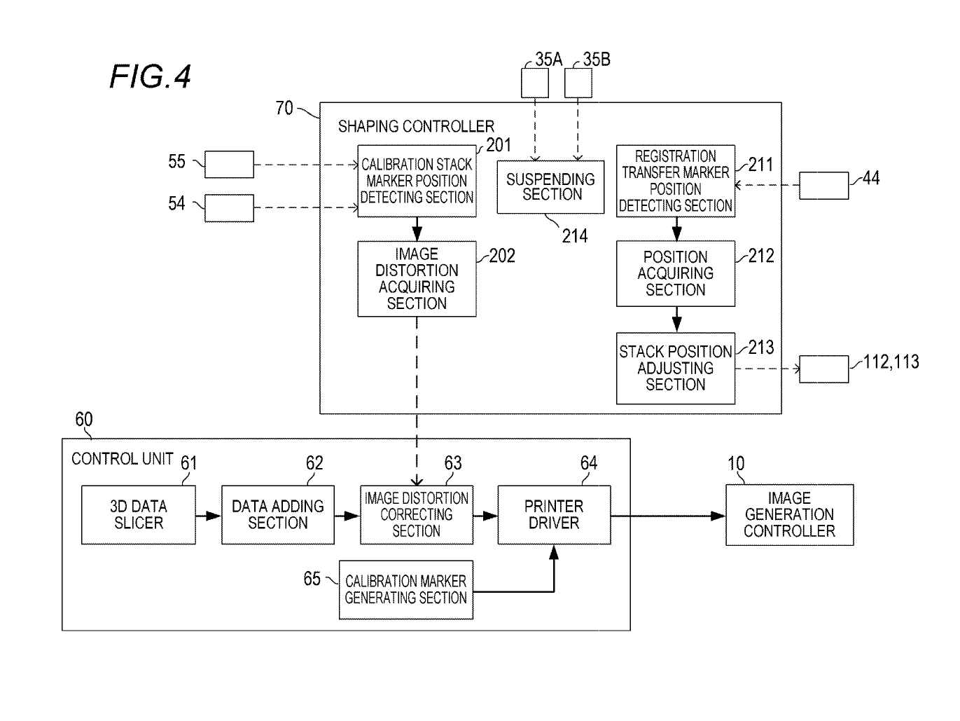

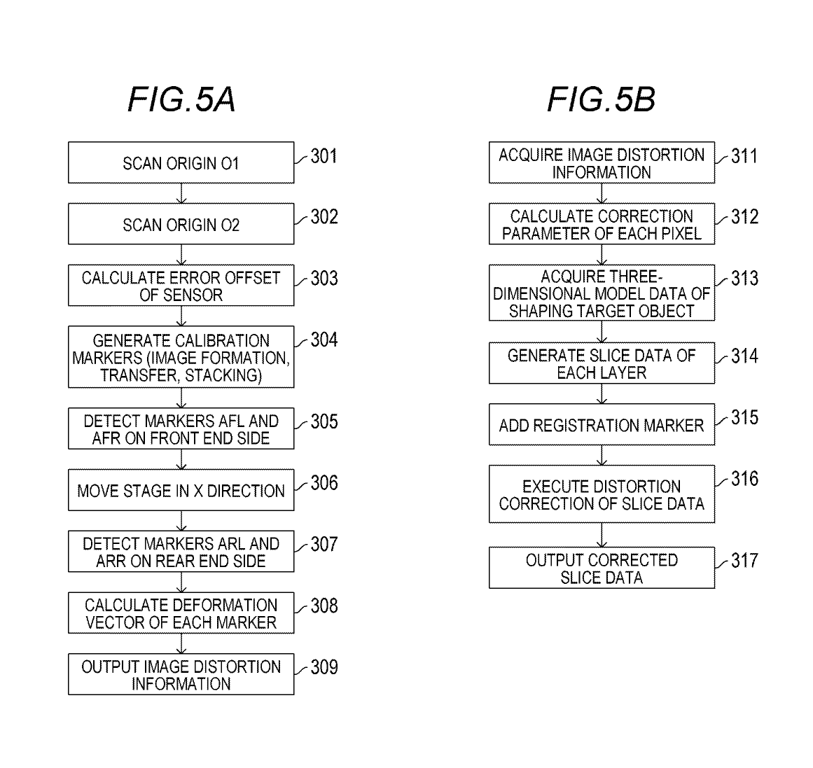

Details of offline calibration will be described with reference to FIGS. 4 and 5A. FIG. 4 is a block diagram showing functions related to offline calibration and FIG. 5A is a processing flow of offline calibration.

As shown in FIG. 4, the control unit 60 includes a calibration marker generating section 65 as a function related to offline calibration. In addition, the shaping controller 70 includes a calibration stack marker position detecting section (a marker detecting section) 201 and an image distortion acquiring section 202 as functions related to offline calibration. The calibration stack marker position detecting section 201 is a function of detecting positions of the respective markers AFL, AFR, ARL, and ARR based on sensing results of the material left front end sensor 54 and the material right front end sensor 55. The image distortion acquiring section 202 is a function of obtaining deformation vectors VFL, VFR, VRL, and VRR of the respective markers.

A flow of offline calibration by the shaping controller 70 will be described based on the flow chart shown in FIG. 5A.

In step 301, the shaping controller 70 monitors output of the material left front end sensor 54 while changing an XY position of the stage 52 by controlling the stage X-drive motor 112 and the stage Y-drive motor 113. Upon detecting the origin O1, the shaping controller 70 stores the XY position of the stage 52 at that point as X=0, Y=0. In step 302, the shaping controller 70 monitors output of the material right front end sensor 55 while changing the XY position of the stage 52 in a similar manner. In step 303, the shaping controller 70 stores a difference between an XY position of the stage 52 upon detection of the origin O2 and an XY position of the stage 52 upon detection of the origin O1 as X=dx, Y=dy. This (dx, dy) is an error offset amount representing attachment errors of the material left front end sensor 54 and the material right front end sensor 55. When the attachment errors of the two sensors 54 and 55 are negligible (in other words, when dx=dy=0 can be assumed), processes of steps 302 and 303 may be omitted.

In step 304, the calibration marker generating section 65 of the control unit 60 causes the material layer forming section 100 and the shaping unit 200 to perform a process of generating a calibration stack marker by outputting calibration marker data to the image generation controller 10. Specifically, based on calibration marker data, the material layer forming section 100 forms a calibration marker made of the shaping material on the photosensitive drum 34 in a same process as forming a material layer of a shaping object. The marker is transferred from the photosensitive drum 34 onto the transfer body 42 and conveyed to the shaping unit 200 as a calibration transfer marker. When a front end of a calibration transfer marker is detected by the material front end detection sensor 45, the shaping controller 70 controls the stage 52 so that the stage 52 enters a stack position at a same timing as the calibration transfer marker. Subsequently, the calibration transfer marker is transferred onto the stage 52 by the heater roller 43 and a calibration stack marker is obtained. As shown in FIG. 3B, the calibration stack markers AFL, AFR, ARL, and ARR include information on image distortion having occurred in processes from the material layer forming step to the shaping step or, more specifically, in a series of processes such as exposure, developing, transfer, and stacking.

In step 305, the shaping controller 70 monitors outputs of the material left front end sensor 54 and the material right front end sensor 55 while changing the XY position of the stage 52 by controlling the stage X-drive motor 112 and the stage Y-drive motor 113. The XY position of the marker AFL detected by the material left front end sensor 54 and the XY position of the marker AFR detected by the material right front end sensor 55 are stored in the calibration stack marker position detecting section 201. In step 306, the shaping controller 70 controls the stage X-drive motor 112 to move the stage 52 to positions of the rear end calibration stack markers ARL and ARR. In step 307, the shaping controller 70 monitors outputs of the material left front end sensor 54 and the material right front end sensor 55 while changing the XY position of the stage 52 by controlling the stage X-drive motor 112 and the stage Y-drive motor 113. The XY position of the marker ARL detected by the material left front end sensor 54 and the XY position of the marker ARR detected by the material right front end sensor 55 are stored in the calibration stack marker position detecting section 201.

In step 308, based on the XY position of the origin O1, the image distortion acquiring section 202 calculates XY positions (referred to as normal positions) of the respective markers AFL, AFR, ARL, and ARR when there is no image distortion. In addition, based on the normal position of each marker and a difference from a detection position of each marker as detected in steps 305 and 307, the image distortion acquiring section 202 calculates deformation vectors VFL, VFR, VRL, and VRR which represent an amount of displacement and a direction of displacement of the respective markers. When there is an error offset amount (dx, dy) between the two sensors 54 and 55, the error offset amount (dx, dy) is taken into consideration when calculating the deformation vectors VFR and VRR.

In step 309, the shaping controller 70 transmits the deformation vector of each marker to the control unit 60 as image distortion information related to image distortion that occurs on a material layer during a period from formation thereof by the material layer forming section 100 to stacking on the stage.

(Image Distortion Correction)

Next, image distortion correction that is executed during formation of a material layer based on image distortion information acquired in advance by offline calibration will be described with reference to FIGS. 4 and 5B.

As shown in FIG. 4, the control unit 60 includes a 3D data slicer 61, a data adding section 62, an image distortion correcting section 63, and a printer driver 64 as functions related to slice data generation and image distortion correction. Hereinafter, operations of the control unit 60 during formation of a material layer will be described based on the flow chart shown in FIG. 5B.

In step 311, image distortion information is acquired from the shaping controller 70. In step 312, the image distortion correcting section 63 calculates inverse vectors from the deformation vectors of markers at the four corners obtained as image distortion information and calculates a correction parameter for each pixel by linearly interpolating the inverse vectors. A correction parameter is information indicating, for example, correspondence between a pixel coordinate in an image prior to correction and a pixel coordinate in the image after the correction.

In step 313, data of a three-dimensional model of a shaping target object is read. In step 314, based on three-dimensional model data, the 3D data slicer 61 slices a three-dimensional model of the shaping target object at a prescribed pitch (for example, at a thickness of several microns to slightly more than 10 microns) to generate a slice image of each layer. In step 315, the data adding section 62 adds a registration marker to the slice image of each layer to generate slice data. Details of a registration marker will be provided later. As an alternative to steps 314 and 315, slice data of each layer may be generated by adding a stack body of registration markers to data of the three-dimensional model read by the data adding section 62 and then having the 3D data slicer 61 perform slicing. In addition, in the re-calibration process (to be described later), data for forming, in a marker area, a stack portion that acts as a base when stacking a calibration maker during shaping of a shaping object is added to slice data of each layer.

In step 316, the image distortion correcting section 63 performs distortion correction of slice data using the correction parameter obtained in step 312. The distortion correction at this point is a process of imparting distortion in an opposite direction to a slice image so that image distortion that occurs during the processes from material layer formation to shaping is reduced or canceled. Moreover, besides performing distortion correction on data after slicing by the 3D data slicer 61, distortion correction of slice data can be performed by performing distortion correction on data of the three-dimensional model prior to slicing. In step 317, the printer driver 64 transmits slice data after correction to the image generation controller 10.

As described above, by correcting sliced image data based on image distortion information obtained by offline calibration, a material layer with no or small image distortion when stacked on the stage 52 can be formed and dimensional accuracy of a shaping object can be improved.

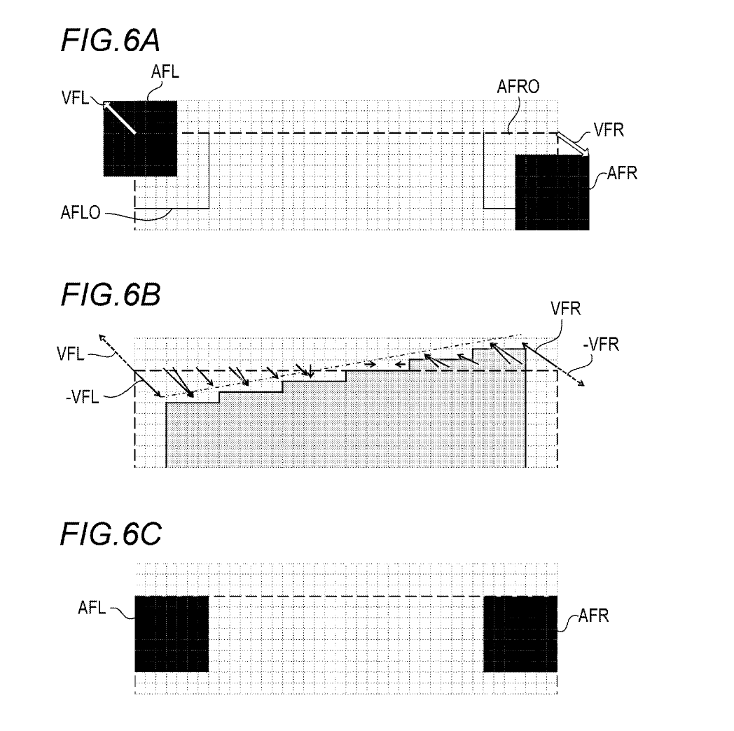

A concept of image distortion correction will be described with reference to FIGS. 6A to 6C. FIGS. 6A to 6C only show correction of pixels of an upper end side of an image for the sake of brevity (in actual correction, similar correction is performed on all pixels in the image).

A dashed line in FIG. 6A indicates a shaping area on the stage 52 and white squares AFLO and AFRO to the left and right of the shaping area indicate normal positions of calibration stack markers in a state where there is no image distortion. In addition, black squares AFL and AFR indicate positions where calibration stack markers are actually stacked during offline calibration. VFL and VFR respectively represent deformation vectors of the markers AFL and AFR. The example in FIG. 6A shows that an image has been extended leftward and rightward, a left side of the image has advanced from the normal position, and a right side of the image has retreated from the normal position.

FIG. 6B schematically shows a concept of image distortion correction. A dashed line indicates a shaping area on the stage 52 and a solid line virtually shows a region of a slice image after correction. At a top left edge of the image, a pixel is moved by an inverse vector −VFL of the deformation vector VFL. At a top right edge of the image, a pixel is moved by an inverse vector −VFR of the deformation vector VFR. At positions between the top left edge and the top right edge, pixels are moved and thinned by linear interpolation of the inverse vectors −VFL and −VFR. Moreover, since a slice image used in shaping is a binary image (presence or absence of material particles), each pixel cannot have an intermediate gradation. Therefore, correction of image distortion (movement of pixels) is performed in pixel units and an edge of the image after correction takes a stepped shape as shown in FIG. 6B. As for pixel thinning, simple thinning is performed in which, when two pixels have a same destination of movement as shown in FIG. 6B, any one of the pixels is deleted.

FIG. 6C shows an image formed on the stage 52 when material layer formation and shaping are performed using the slice data after correction indicated by the solid line in FIG. 6B. The calibration stack markers AFL and AFR are stacked at normal positions and front ends are uninclined straight lines. Accordingly, a stack without image distortion can be realized. Although not strictly expressed herein, an upper end edge of the image has a stepped shape and pixels are partially inclined. The number of pixels is small and an actual box (one pixel) is slightly expanded such that a horizontal width equals a normal width. In the case of a particle when one pixel is 50 microns, an expansion or contraction of 1% equates to an expansion or contraction of 0.5 microns, which is not visually recognizable at an entire image level.

(Online Registration)

Next, online registration that is performed during stacking of a material layer will be described. In online registration, a registration marker is inserted to a material layer and positioning during stacking is performed based on a detection position of the marker.

In the following description, image data for a registration marker to be supplied to the image generation controller 10 will be referred to as “registration marker data”. In addition, an image made of shaping material formed based on registration marker data will be referred to as a “registration marker” or simply a “marker”. Furthermore, a marker transferred to the transfer body 42 from the photosensitive drum 34 (in other words, a marker on the transfer body 42) will be referred to as a “registration transfer marker” and a marker transferred onto the stage 52 will be referred to as a “registration stack marker”. The name of a marker is changed from one location to another because locations of the marker are favorably distinguished from one another for the same of brevity due to the fact that image distortion may change as the marker is transferred, the marker is detected using a different sensor at each location, and the like. Moreover, in a context where locations need not be particularly distinguished, the term “registration marker” or “marker” will be used.

As shown in FIG. 4, the shaping controller 70 includes a registration transfer marker position detecting section 211, a position acquiring section 212, and a stack position adjusting section 213 as functions related to online registration.

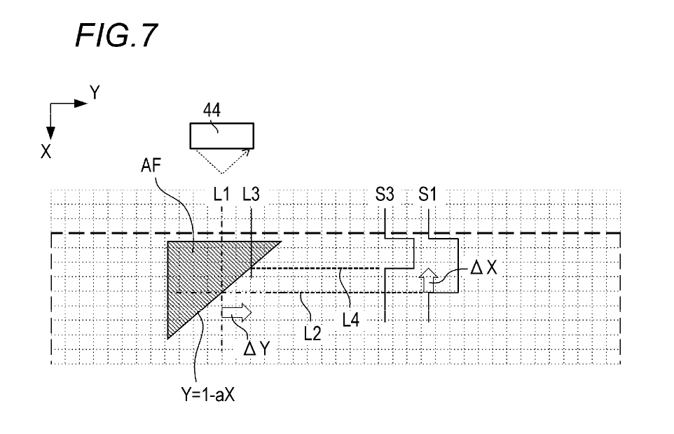

As described with reference to step 315 in FIG. 5B, an image of a registration marker for positioning is embedded in slice data of each layer. In the present embodiment, as shown in FIG. 7, a registration marker AF that is a right triangle is formed at a prescribed position (a position not overlapping with a section of a shaping object) in a shaping area.

The registration transfer marker position detecting section 211 detects the registration transfer marker AF on the transfer body 42 using the material front end detection sensor 44. Subsequently, the position acquiring section 212 acquires an X-direction position (a front end position) and an amount of deviation of a Y-direction position of the material layer based on a result of detection of the registration transfer marker AF. In this case, the X-direction refers to a direction of forward movement of the transfer body 42 and the Y-direction refers to a width direction (a direction perpendicular to the direction of forward movement) of the transfer body 42. Based on the X-direction position of the material layer, the stack position adjusting section 213 controls a drive start timing of the stage X-drive motor 112 and aligns a front end of the shaping object on the stage 52 with a front end of the material layer on the transfer body 42. In addition, based on the amount of deviation of the Y-direction position of the material layer, the stack position adjusting section 213 controls the stage Y-drive motor 113 and aligns a left end of the shaping object on the stage 52 with a left end of the material layer on the transfer body 42. Accordingly, a stacking variation in an XY plane between the shaping object and the material layer is eliminated online and high-quality shaping can be performed.

FIG. 7 is a conceptual diagram of detection of a registration transfer marker on a transfer body. The registration transfer marker AF is formed at a prescribed position (a position not overlapping with a section of a shaping object) in a front end portion of a shaping area on the transfer body 42. The registration transfer marker AF according to the present embodiment is a graphic with a shape of a right triangle having a first edge that is perpendicular to a direction of forward movement of the transfer body 42 (X direction) and a second edge that is oblique to the X direction.

An amount of variation of the hypotenuse of the right triangle is expressed by an equation as

Y=1−aX,

where a denotes an incline of the hypotenuse and a length of one side of the triangle is 1.

When a left end side of the registration transfer marker AF transferred without deviation is assumed to be Y=0 and a normal position is assumed to be Y=0.5, an amount of deviation ΔY can be expressed as

ΔY=Y−0.5=(1−aX)−0.5=0.5−aX.

When the incline of the hypotenuse is 45°, a=1, and

ΔY=0 when X=0.5,

ΔY=0.5 when X=0, and

ΔY=−0.5 when X=1, where 0<X<1.

The first edge and the second edge of the registration transfer marker AF are detected by the material front end detection sensor 44. L1 denotes a detection line of the material front end detection sensor 44 when the registration transfer marker AF on the transfer body 42 passes the normal position. In other words, a state where the material front end detection sensor 44 passes the line L1 constitutes a reference (amount of deviation ΔY=0). S1 denotes an output signal of the material front end detection sensor 44 when passing the line L1. When the first edge of the registration transfer marker AF is detected, the signal changes from a low level to a high level. When a second edge L2 is detected, the signal changes from a high level to a low level.

Supposing that the transfer body 42 shifts to the left by ΔY from the reference, the material front end detection sensor 44 passes a line L3. S3 denotes an output signal of the material front end detection sensor 44 when passing the line L3. When the first edge of the registration transfer marker AF is detected, the signal changes from a low level to a high level. When a second edge L4 is detected, the signal changes from a high level to a low level.

Therefore, an X-direction position (a front end position) can be obtained based on a timing of rising of the output signal S3 of the material front end detection sensor 44. In addition, the amount of deviation ΔY of the Y-direction position of the registration transfer marker with respect to the normal position can be obtained from a high-level period of the output signal S3 (a difference between a detection timing of the first edge and a detection timing of the second edge) and the equation Y=1−aX. As described above, positions in the two directions X and Y can be detected with one registration transfer marker and one material front end detection sensor 44. This offers a cost advantage as a result of simplified configurations and processes as well as an advantage that positioning in two directions can be performed at high speed. Since the transfer body 42 and the stage 52 move at high speed during stacking, a configuration such as that of the present embodiment is effective. However, when the deviation of the Y-direction position is small enough to be negligible, the X-direction position need only be detected and, for example, a quadrangular marker having two sides parallel to the Y direction and two sides parallel to the X direction can be used.

According to the configuration described above, by performing offline calibration and image distortion correction, a distortion in an XY plane of an image which occurs during processes from material layer formation to shaping can be minimized. In addition, by performing online registration, a deviation of a position during stacking can be minimized. Therefore, a high-quality shaping object with high shape accuracy and high dimensional accuracy can be formed.

While a case where one process cartridge is provided has been described heretofore for the sake of brevity, in the present embodiment, a plurality of process cartridges are provided. Such a configuration can be used for the purpose of, for example, readily forming a shaping object having a support body made of a material that differs from that of the shaping object main body (for example, a material with high removability) by injecting a support material into one of the plurality of cartridges. In this case, data related to information on the support material is added to slice data of the shaping target object and the control section generates slice data for shaping. The configuration can also be used for the purpose of injecting a same material into two of the plurality of cartridges, performing material layer formation by one process cartridge, and when the material is used up, automatically switching to the other process cartridge to continue material layer formation. The configuration can also be used for the purpose of injecting materials with different colors or physical properties into a plurality of cartridges to create a colorful shaping object or a shaping object that mixes a plurality of materials.

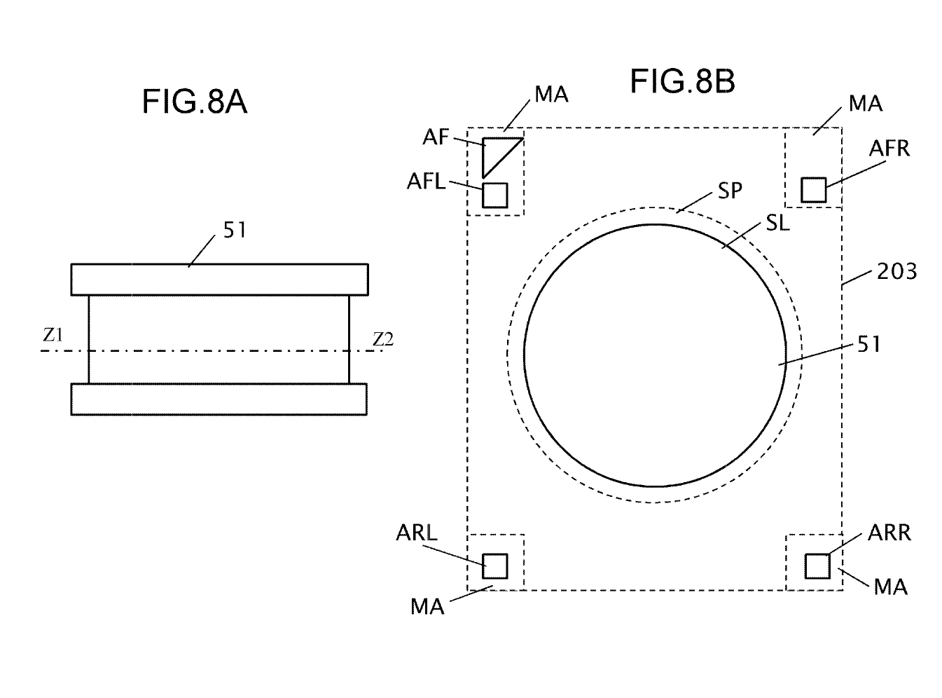

An image area according to the present embodiment will now be defined using FIGS. 8A and 8B. The mode described below is assumed to be a mode which includes two process cartridges and which uses two types of shaping materials. As the shaping materials, a build material and a support material are to be used.

An example of a cylindrical shaping object with flanges on both ends as the shaping target object 51 will now be described. FIG. 8A shows a side view of the cylindrical shaping target object 51. FIG. 8B is a diagram in which the shaping target object 51 formed on the stage 52, the calibration markers AFL, AFR, ARL, and ARR, and the registration marker AF are seen from above the stage 52 and presents a section of the shaping target object 51 taken along Z1-Z2 in FIG. 8A.

In FIG. 8B, SL denotes a build body and SP denotes a support body that supports the flanges from below during stacking. In addition, in FIG. 8B, regions inside dashed lines respectively enclosing the calibration markers AFL, AFR, ARL, and ARR are assumed to be marker areas MA. A marker support body MS for stacking a calibration marker during shaping is formed in the marker areas MA. While a description will be given later, when the marker support body MS is formed in the marker areas MA, a region in which shaping of a shaping object can be performed is a region excluding the marker areas MA in the image area 203 shown in FIG. 8B.

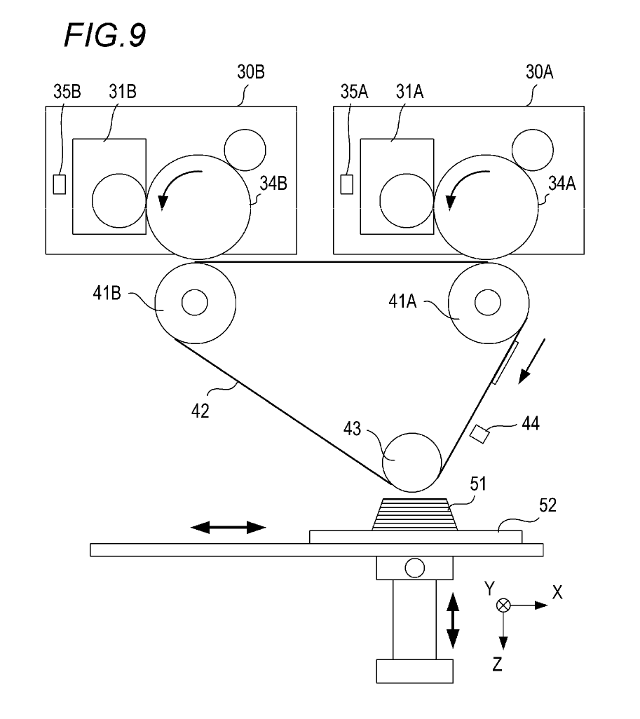

FIG. 9 is a diagram showing a configuration of a shaping system including two process cartridges. The example shown in FIG. 9 is provided with a photosensitive drum 34A, a first cartridge 30A including a transfer roller 41A, a photosensitive drum 34B, and a second cartridge 30B including a transfer roller 41B. In addition, a build material is stored in the cartridge 30A and a support material is stored in the cartridge 30B in respective shaping material supplying sections 31 (storage sections) thereof. When performing shaping using two types of shaping materials as shown in FIG. 9, a layer created by combining, on the transfer body, a layer made of the build material and formed on the photosensitive drum 34A and a layer made of the support material and formed on the photosensitive drum 34B constitutes a material layer used in one stacking operation.

(Re-Calibration Process)

Hereinafter, a re-calibration process that is a feature of the present embodiment will be described. A configuration including two cartridges and two materials is assumed as a shaping system such as that shown in FIG. 9 and, as shown in FIG. 4, the shaping controller 70 includes a suspending section 214 having a function of suspending a shaping operation of a shaping object based on sensing results of remaining amount detection sensors 35A and 35B.

There are cases where the build material inside the cartridge 30A is used up during a shaping operation of a shaping object and the shaping operation is suspended. In such a case, the remaining amount detection sensor 35A detects that a remaining amount of the shaping material in the shaping material supplying section 31A is less than a threshold and sends a material absent detection signal to the shaping controller 70. As a result, a display to the effect that the shaping material in the cartridge 30A has been used up or the cartridge 30A needs to be replaced is displayed in the UI section 74 shown in FIG. 2. Due to the display, a user realizes that the material is used up and replaces the cartridge 30A.

When the cartridge 30A has been replaced and the remaining amount detection sensor 35A detects that the remaining amount of the shaping material in the shaping material supplying section 31A is now equal to or more than the threshold, suspension of the shaping operation of the shaping object is canceled and the shaping operation of the shaping object is restarted.

A feature of the present embodiment is that, even when a shaping operation is restarted after being suspended in this manner, a re-calibration process that is a similar process to the offline calibration and the image distortion correction described earlier is performed.

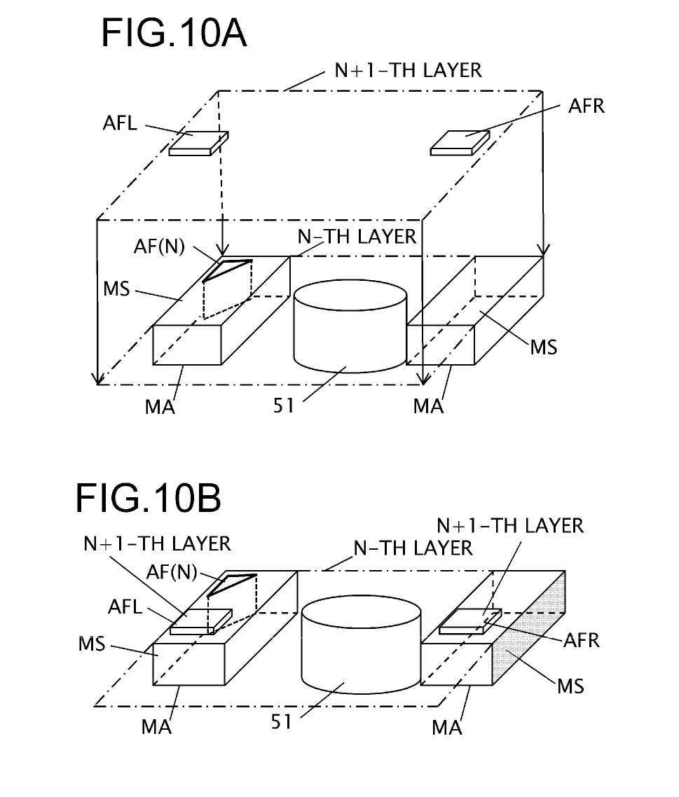

FIGS. 10A to 12B are diagrams for illustrating a re-calibration process after a shaping material is used up during shaping and a cartridge is replaced. Moreover, as the calibration markers shown in FIGS. 10A to 12B, only the calibration markers in a front end portion are shown for the sake of brevity.

FIG. 10A shows a state where the shaping material in the cartridge 30A has run out upon completion of stacking of an N-th layer during stacking and the shaping controller 70 detects “material absent” with the remaining amount detection sensor 35A and suspends the stacking operation.

As shown in FIG. 10A, at a left end in the shaping area, the triangular registration marker AF is consecutively stacked as a shaping object without modification from the transfer body and a registration marker AF(N) of the N-th layer is positioned on a surface (top surface).

In addition, during a re-calibration process that is executed after restarting the shaping operation, a marker support body MS that acts as a base when stacking calibration markers is also formed as a shaping object. The marker support body MS is formed when a calibration support image that constitutes a part of a material layer is consecutively stacked as a part of the shaping object. In addition, the marker support body MS is formed when data is added by the data adding section (a marker area adding section) 62 shown in FIG. 4 when slice data of each layer is generated by the control unit 60 shown in FIG. 1. This data is data for forming, in a marker area, a stack portion that acts as a base when stacking a calibration maker during shaping of a shaping object.

Subsequently, the shaping operation can be restarted as the user replaces the cartridge 30A.

When the cartridge 30A is replaced and the remaining amount detection sensor 35A detects “material present” with respect to the shaping material in the cartridge 30A, the shaping controller 70 restarts the shaping operation of the shaping object on the stage. At this point, a re-calibration process is performed by a control section.

In addition, there may be cases where, due to shaping over a long period of time, image distortion occurring in a material layer changes after the material layer is formed by the material layer forming section 100 and before being stacked on the stage. Even in such cases, a re-calibration process may be performed during shaping.

Hereinafter, the re-calibration process will be described in greater detail.

First, a calibration marker is generated in a similar manner to step 304 in FIG. 5A. The generated calibration marker is stacked at a position corresponding to an N+1-th layer of a shaping object on the stage.

FIG. 10B shows a state where a front left end calibration marker AFL and a front right end calibration marker AFR are stacked on the N+1-th layer of the shaping object on the stage. In this manner, the front left end calibration marker AFL and the front right end calibration marker AFR are generated as a material layer of the N+1-th layer and stacked on the shaping object on the stage. At this point, as shown in FIG. 10B, a calibration marker protrudes upward with respect to a shaping object in a state where material layers corresponding to N-number of layers have been stacked. While this calibration marker may possibly be stacked at a distorted position that deviates from the normal position in a similar manner to FIG. 6C, image distortion information is acquired from the deviation of the position of the marker in a similar manner to offline calibration and image distortion correction is performed.

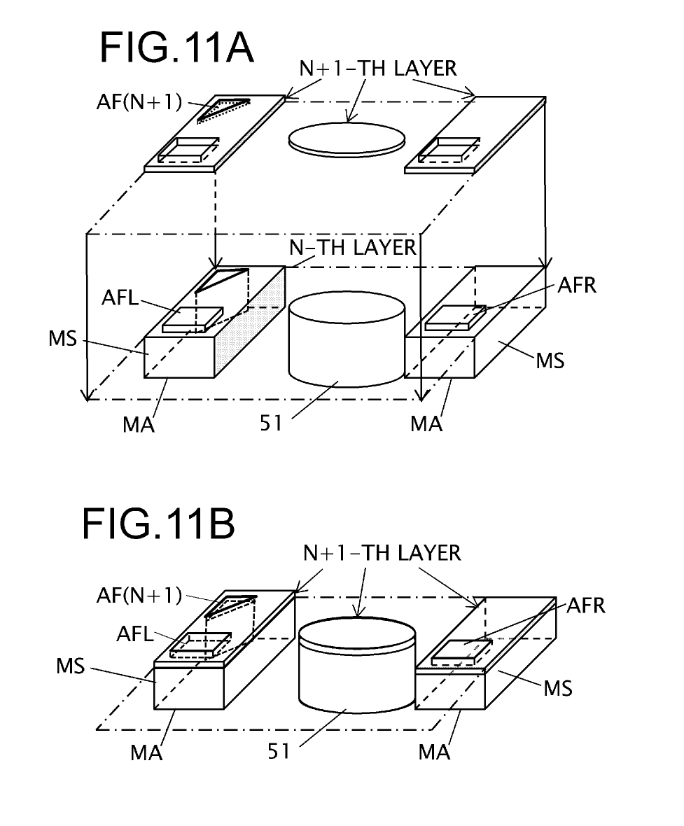

FIG. 11A is a diagram illustrating a concept of a shaping operation of a shaping object which is performed immediately after stacking of a calibration marker.

Since a marker portion protrudes from a top surface of the shaping object on the stage as described above immediately after stacking of a calibration marker, the protruding portion must be removed and the top surface of the shaping object must be flattened in order to continue stacking. Therefore, a calibration support image to be stacked on the marker support body MS immediately after stacking of a calibration marker is formed so as to be stacked in a region other than an arrangement region of the calibration marker of a top surface of the marker support body MS. Specifically, a calibration support image having an opening corresponding to the calibration marker AFL of the N+1-th layer is formed. In this case, although image distortion correction is performed with respect to a sectional image of the build body of the N+1-th layer and an image of the registration marker AF (N+1), correction is not performed with respect to the opening corresponding to the calibration marker AFL of the N+1-th layer. This is because, in order to flatten the protrusion of the calibration marker of the N+1-th layer, the opening formed in the calibration support image of the N+1-th layer must be in a state including a same image distortion as the calibration marker of the N+1-th layer.

As described above, after restarting the shaping operation, a calibration support image excluding an arrangement region of a calibration marker, the registration marker AF (N+1), and a portion corresponding to a section of the build body are stacked on the shaping object as the material layer of the N+1-th layer. Material layers stacked after the N+1-th layer are in a state of being subjected to the re-calibration process.

FIG. 11B shows a state where, after the shaping operation, the material layer of the N+1-th layer is stacked. As shown in FIG. 11B, by stacking the material layer of the N+1-th layer, the top surface of the shaping object becomes flat once again and normal stacking can be subsequently executed.

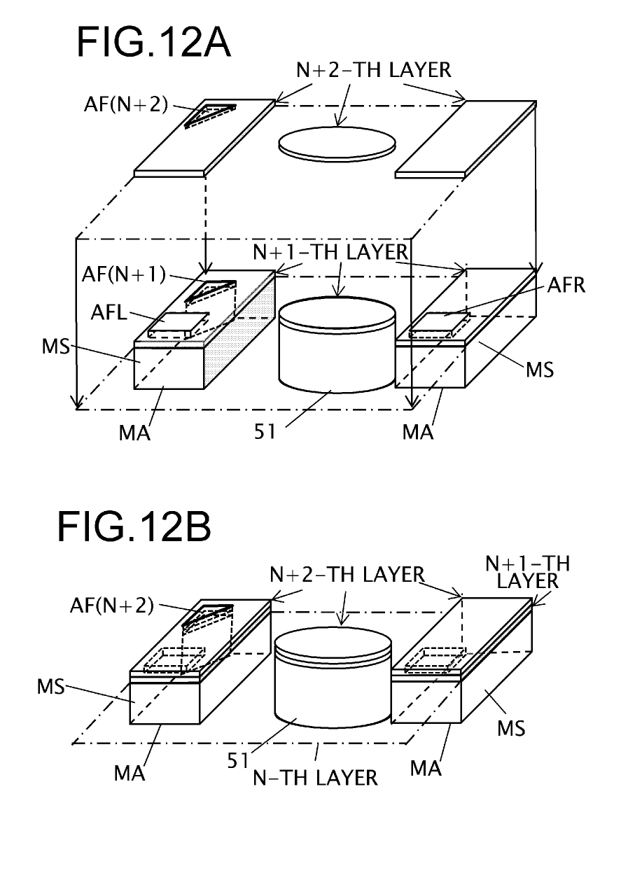

FIG. 12A is a diagram illustrating a concept of continuation of a normal stacking operation from an N+2-th layer.

As the material layer of the N+2-th layer, a calibration support image, a registration marker AF (N+2), and a portion corresponding to a section of the build body are stacked on the shaping object on the stage.

FIG. 12B is a diagram showing a state where the material layer of the N+2-th layer has been normally stacked. Since distortion correction is continuously performed on slice data with respect to a portion corresponding to a section of the build body without thinning and overlapping even when a shaping operation is suspended, a faithful shaping object with high accuracy can be formed. Moreover, the calibration marker that is formed upon suspension of a shaping operation and the marker support body MS on which the calibration marker is stacked are discarded after stacking is completed.

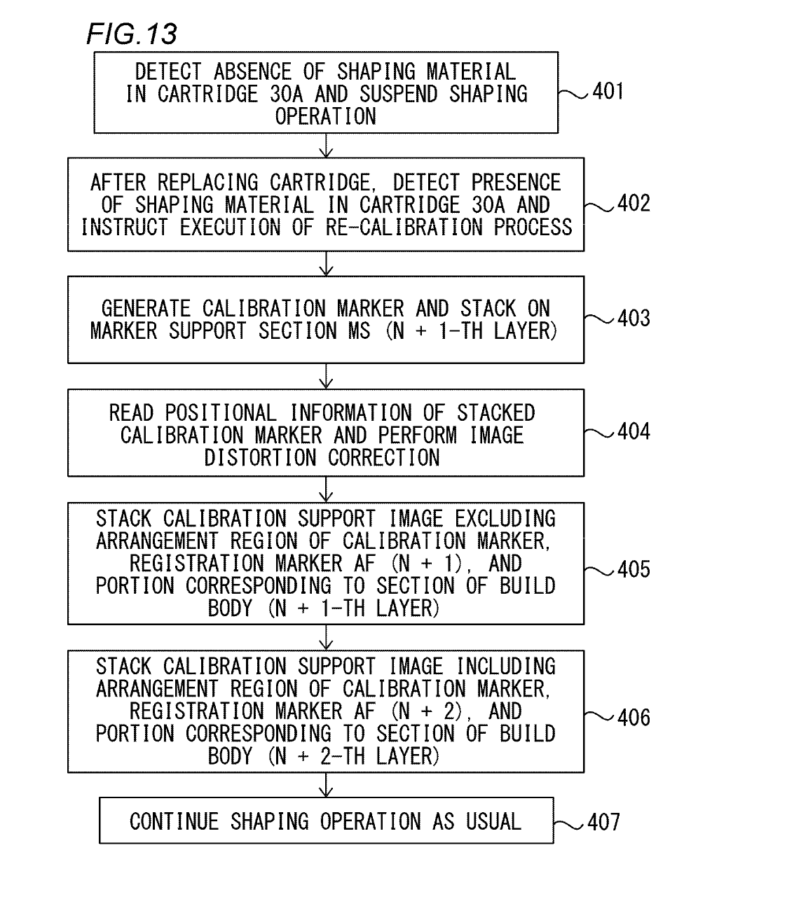

FIG. 13 is a flow chart for providing a step-by-step explanation of the process described above. Step 401: After the material layer of the N-th layer is stacked, when the remaining amount detection sensor 35A detects absence of the shaping material in the cartridge 30A, the shaping controller 70 suspends the shaping operation.

Step 402: After absence of the shaping material is displayed and the user replaces the cartridge, the remaining amount detection sensor 35A detects presence of the shaping material in the cartridge 30A and the shaping controller 70 instructs execution of the re-calibration process.

Step 403: A calibration marker is generated with the shaping material in the cartridge 30A, and a material layer is formed and stacked on the marker support body MS formed in the marker area (N+1-th layer).

Step 404: When the material left front end sensor 54 and the material right front end sensor 55 detect positional information of the calibration marker stacked on the marker support body MS, the control unit 60 performs image distortion correction.

Step 405: A calibration support image excluding an arrangement region of the calibration marker in the N+1-th layer, a registration marker AF (N+1), and a portion corresponding to a section of the build body are stacked on the shaping object on the stage (N+1-th layer). At this point, the calibration support image excluding the arrangement region of the calibration marker and the registration marker AF (N+1) are stacked on the marker support body MS.

Step 406: A calibration support image including the arrangement region of the calibration marker in the N+1-th layer, a registration marker AF (N+2), and a portion corresponding to a section of the build body are stacked on the shaping object on the stage (N+2-th layer). At this point, the calibration support image including the arrangement region of the calibration marker in the N+1-th layer and the registration marker AF (N+2) are stacked on the marker support body MS.

Step 407: The shaping operation is continued as normal.

As described above, according to the present embodiment, since a re-calibration process can be executed during shaping and image distortion correction can be performed during shaping in accordance with a calibration result, shaping with high shape accuracy can be realized.

While a re-calibration process is executed upon restart of a shaping operation after the shaping operation is suspended when replacing a cartridge in the present embodiment, the execution of a re-calibration process is not limited thereto. A re-calibration process may be executed during shaping of a shaping object upon restart of a shaping operation after the shaping operation is suspended as necessary. In addition, a re-calibration process may be inserted between shaping operations and may be executed as necessary without suspending a shaping operation. Image distortion attributable to formation of a material layer occurs due to, for example, distortion of the photosensitive drum 34, distortion of the developing roller 32, a deviation in alignment of each roller shaft, abrasion of each member, and a thermal change in each member in accordance with a temperature change inside an operating apparatus. Therefore, a re-calibration process is favorably executed as necessary such as when a period of use of the cartridge 30 reaches a prescribed value.

In addition, while a case where offline calibration and a re-calibration process are executed has been described in the present embodiment, this is not restrictive and a configuration in which only a re-calibration process is executable may be adopted. When image distortion is negligible, offline calibration may be omitted. In this case, for example, a re-calibration process is favorably executed at a timing (during shaping) when shape accuracy of a shaping object is required after start of a shaping operation of the shaping object.

Furthermore, while a build material is stored in the cartridge 30A and a support material is stored in the cartridge 30B in the present embodiment, this is not restrictive when a support body is not required during shaping. In other words, a calibration marker to be stacked on the marker support body MS need only be detected by the material left front end sensor 54 and the material right front end sensor 55 during a re-calibration process. Therefore, a material constituting the calibration marker and a material constituting the marker support body MS may be set as appropriate.

In addition, while only calibration markers in a front end portion are displayed in the description of a re-calibration process, as described in the section titled Offline calibration, this is not restrictive. Image distortion information can be acquired in a re-calibration process even when using the rear left end calibration marker ARL and the rear right end calibration marker ARR in a rear end portion.

Furthermore, when the support material in the cartridge 30B is used up instead of the build material in the cartridge 30A, a re-calibration process is performed when the cartridge is replaced in a similar manner to the description given earlier. This also applies to cases where there are three or more process cartridges (material arranging sections), in which case a marker may be individually generated for each process cartridge.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-131866, filed on Jun. 30, 2015 and Japanese Patent Application No. 2016-118338, filed on Jun. 14, 2016, which are hereby incorporated by reference herein in their entirety.

What is claimed is:

1. A shaping system that fabricates a shaping object by stacking a material layer formed based on slice data, the shaping system comprising:
a control section which controls operations of respective sections of the shaping system;
a marker generating section which generates data of a marker;
a slice data generating section which generates the slice data by adding data for fabricating a marker support body to become a base on which the marker is stacked to data of a three-dimensional model;
a material layer forming section which forms a material layer made of a shaping material based on the data of the marker or the slice data;
a stage on which the material layer is stacked;
a marker position detecting section which detects a position of the marker stacked on the stage or the marker support body;
an image distortion acquiring section which acquires information on image distortion occurring in the material layer from a detection result of the marker position detecting section; and
a correcting section which reduces the image distortion with respect to the slice data based on the image distortion information acquired by the image distortion acquiring section, wherein
the control section controls the respective sections so that, at a prescribed timing,
the marker is formed and stacked on a top surface of the marker support body, image distortion information is acquired from a position of the marker as detected by the marker position detecting section, and a correction process for correcting the slice data is executed.

2. The shaping system according to claim 1, wherein the control section includes a suspending section which suspends an operation by the material layer forming section for forming a material layer made of a shaping material based on the slice data, and the correction process is executed after the suspension of the operation for forming the material layer by the suspending section.

3. The shaping system according to claim 2, further comprising
a remaining amount detecting section which detects a remaining amount of the shaping material, wherein
when the remaining amount of the shaping material as detected by the remaining amount detecting section drops below a threshold, the suspending section suspends the operation for forming the material layer.

4. The shaping system according to claim 3, wherein when the remaining amount detecting section detects that the remaining amount of the shaping material is equal to or more than the threshold after the operation for forming the material layer has been suspended, the suspending section cancels the suspension of the operation for forming the material layer and the control section executes the correction process.

5. The shaping system according to claim 3, further comprising
a storage section which stores the shaping material so that the storage section is attachable and detachable with respect to a system main body, wherein
the remaining amount detecting section detects a remaining amount of the shaping material stored in the storage section.

6. The shaping system according to claim 1, wherein the slice data generating section generates data having an opening corresponding to a shape of the marker stacked on the marker support body as slice data of a material layer to be stacked after the correction process is executed.

7. The shaping system according to claim 1, wherein
the control section forms the marker with a first shaping material constituting the three-dimensional model, and
forms the marker support body with a second shaping material constituting a support body that supports the shaping object during a shaping operation.

8. The shaping system according to claim 1, wherein the image distortion acquiring section acquires information on image distortion in a shaping area on the stage or information on image distortion in a shaping object on the stage based on a difference between a detection position of the marker by the marker position detecting section and a normal position that is a position where the marker is to be stacked when there is no image distortion.

9. The shaping system according to claim 1, wherein the marker includes a plurality of markers to be respectively stacked on a plurality of marker support bodies.

10. The shaping system according to claim 1, wherein the marker includes a plurality of markers to be respectively stacked on the marker support body arranged at four corners in a rectangular shaping area on the stage.

11. The shaping system according to claim 9, wherein the image distortion acquiring section acquires information on image distortion in a shaping area on the stage by linear interpolation between positions of the plurality of markers.

12. The shaping system according to claim 1, wherein the material layer forming section forms a material layer using an electrophotographic process.

13. A shaping object manufacturing method that repetitively performs, a plurality of times, a set of
a material layer forming step of forming a material layer made of a shaping material based on slice data generated from three-dimensional model data and
a shaping step of sequentially stacking the material layer formed in the material layer forming step, wherein
a correction process step of correcting the slice data is inserted between each repetition of the set.

14. The shaping object manufacturing method according to claim 13, wherein
in the correction process step, a marker made of a shaping material is formed based on data forming a marker and the marker is stacked on a shaping object,
positional information of the marker is acquired, image distortion information is acquired from a difference between a detection position of the marker and a position where the marker is to be stacked when there is no image distortion, and
the slice data is corrected based on the image distortion information.

15. The shaping object manufacturing method according to claim 14, wherein
the slice data is generated by adding data for fabricating a marker support body to become a base on which the marker is stacked to data of a three-dimensional model, and
in the correction process step, the marker is stacked on a top surface of the marker support body.

16. The shaping object manufacturing method according to claim 15, wherein
in the correction process step,
a process of providing an opening in a region corresponding to a stacking position of the marker is performed with respect to slice data of a material layer that is formed after stacking the marker.

17. The shaping object manufacturing method according to claim 14, wherein in the material layer forming step, a material layer is formed using an electrophotographic process.

18. A data processing method used in a shaping system which fabricates a shaping object by performing, a plurality of times, a step of forming a material layer made of a shaping material based on slice data and a step of stacking the material layer, the data processing method comprising the steps of:
generating data of a marker for acquiring information used to correct the slice data; and
generating the slice data by adding data for fabricating a marker support body to become a base on which the marker is stacked to data of a three-dimensional model, wherein
when data of the marker is inserted between the plurality of times of performing the step of forming the material layer, a step of providing an opening corresponding to a shape of the marker in slice data of the material layer formed subsequently to the insertion of the data of the marker is performed.

19. The data processing method according to claim 18, wherein
when the data of the marker is inserted between the plurality of times of performing the step of forming the material layer and image distortion information is acquired using the marker,
a step of correcting, based on the distortion information, data included in the slice data of the material layer other than the opening corresponding to the shape of the marker is performed.
